(19) United States
(12) Patent Application Publication
(10) Pub. No.: US 2020/0352331 A1
(43) Pub. Date: Nov. 12, 2020

(54) User Changeable Display Panel Apparatus and Method for Furniture

(71) Applicant: Rebecca L. Graf, Berdietikon (CH)

(72) Inventor: Rebecca L. Graf, Berdietikon (CH)

(21) Appl. No.: 16/405,097

(22) Filed: May 7, 2019

(51) Int. Cl. A47B 96/20; G06F 1/16; B68G 13/00; A47C 31/02; A47C 7/40; A47C 19/02; A47C 17/04; B32B 7/06

(52) U.S. Cl. CPC A47B 96/20; G06F 1/16; B68G 13/00; A47C 31/023; A47C 7/40; A47C 31/003; A47C 17/04; B32B 7/06; A47B 2096/209; A47B 2096/207; A47C 19/02

(57) ABSTRACT

A user changeable display panel apparatus for furniture is disclosed having a receiving panel and a display panel. The receiving panel is configured to be mounted to furniture. The receiving panel comprises a ferromagnetic material. The display panel comprises a cover and a magnetic sheet. The magnetic sheet is opposite of a face of the cover and configured to detachably connect to the receiving panel. The magnetic sheet is substantially coextensive with the cover.

### FIELD OF THE INVENTION

This invention relates in general to user changeable display panel apparatus and methods for furniture.

### BACKGROUND OF THE INVENTION

Furniture upholstery has generally been permanently affixed. If one desired to change the style, covering, or look of such furniture, one would need to either buy new or different furniture, personally reupholster the furniture, or have the furniture professionally reupholstered.

The present inventor recognized that such options are unnecessarily burdensome and costly. For example, the cost can be high to professionally reupholster furniture. Further, there is a hassle in transporting the furniture to the location where professional reupholstery is offered and possible lack of conveniently located professional, reputable reupholstery providers. Further, reupholstering is a labor intensive job requiring experience that many furniture owners may lack. Further, ever-evolving changes in design trends often encourage consumers to update their furniture styles frequently.

Therefore, with traditional furniture upholstery, consumers are forced to settle with their existing furniture, undergo the hassles and costly expenditures of professional reupholstery, attempt to reupholster the furniture themselves, discard their existing furniture or purchase new furniture causing additional negative impacts on the environment due to increased furniture waste. Sometimes the new furniture is constructed with lower quality materials, which is a further loss to the consumer.

The present inventor recognized the need for an apparatus and method that allowed users to change the upholstery of the furniture, easily and economically, without discarding the existing furniture or using professional reupholstery services.

The present inventor recognized the need for an apparatus and method that allowed users to change the upholstery of the furniture supporting eco-friendly solutions by minimizing furniture waste for the environment.

The present inventor recognized the need for an apparatus and method that allowed users to change the upholstery of the furniture without the use of tools or ancillary attachment options such as screws, bolts, snap fasteners, hooks, or hook and loop fasteners.

The present inventor recognized the need for an apparatus and method that allowed users to change the upholstery on furniture while maintaining a professional upholstered appearance, structural integrity, and useful life of the furniture.

### SUMMARY OF THE INVENTION

A user changeable display panel apparatus for furniture is disclosed comprising a receiving panel and a display panel. The receiving panel is configured to be mounted to furniture. The receiving panel comprises a ferromagnetic material. The display panel comprises a cover and a magnetic sheet. The magnetic sheet is opposite of a face of the cover and configured to detachably connect to the receiving panel. The magnetic sheet is substantially coextensive with the cover.

A furniture is also disclosed, comprising a frame, an upholstery supported by the frame, a receiving panel, and a display panel. The receiving panel comprises a ferromagnetic material supported by the frame. The display panel comprises a cover and a magnetic sheet. The magnetic sheet is opposite of a face of the cover and configured to detachably connect to the receiving panel. The magnetic sheet is substantially coextensive with the cover.

A method of changing upholstery of furniture is also disclosed. A first display panel is removed from a receiving panel of the furniture by drawing the first display panel away from the receiving panel and overcoming the magnetic attraction of the first display panel to the receiving panel. The receiving panel comprises a ferromagnetic material. A second display panel is attached to the receiving panel by aligning a magnetic sheet on a back of the second display panel with the receiving panel, wherein a cover of the second display panel is opposite the magnetic sheet, and moving the second display panel toward the receiving panel wherein the magnetic attraction of the magnetic sheet to the ferromagnetic material of the receiving panel draws the second display panel to the receiving panel, wherein the magnetic sheet is substantially co-extensive with the cover, the ferromagnetic material is at least co-extensive with the magnetic sheet so that the magnetic attraction between the second display panel and the receiving panel secures and conforms the second display panel to the receiving panel throughout the extent of the second display panel.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a front view of a user-changeable display panel apparatus of the invention deployed on a back upper portion of a chair.

FIG. 2 is an exploded front perspective view of the panel apparatus of FIG. 1.

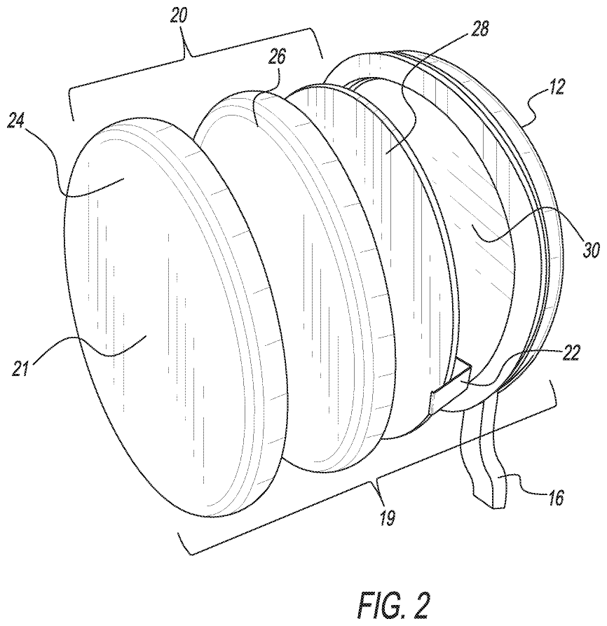

FIG. 3 is a side perspective view of the panel apparatus and a chair back of FIG. 1.

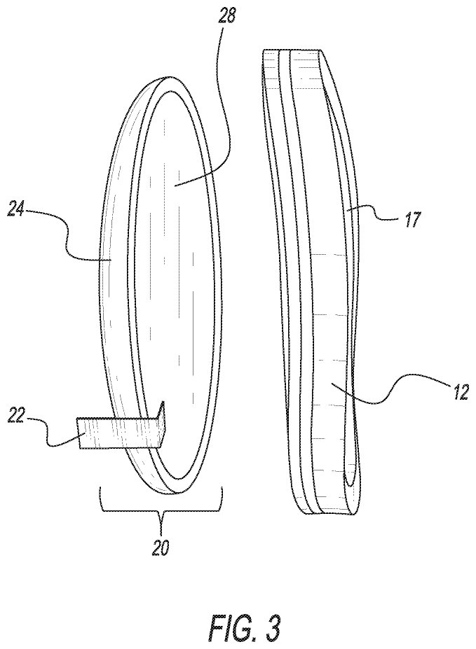

FIG. 4 is a side section view of the panel apparatus of claim 1 taken along line 4-4 of FIG. 1.

FIG. 5 is a front view of a portion of the panel apparatus deployed on an upper portion of a chair of FIG. 1.

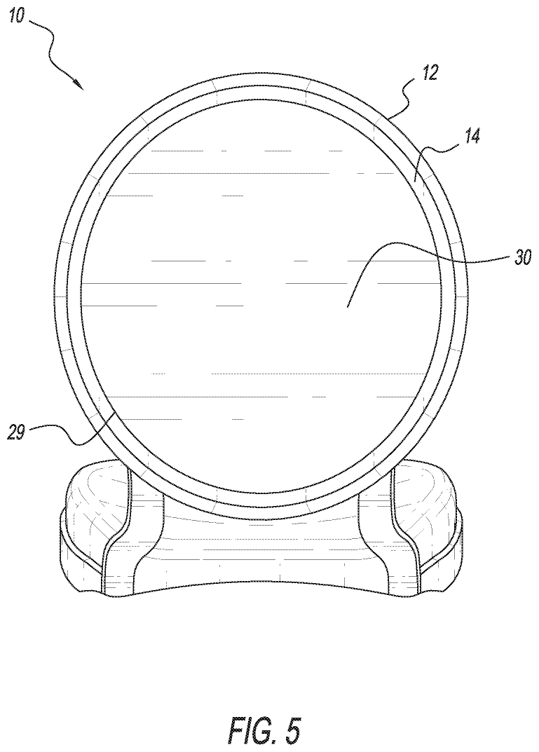

FIG. 6 is an exploded side perspective view of the portion of the chair of FIG. 1 showing a portion of the panel apparatus.

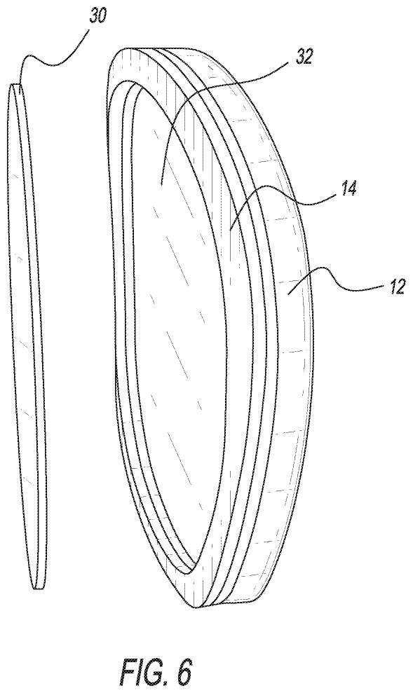

FIG. 7 is a front view of a portion of the panel apparatus deployed on the portion of the chair of FIG. 1.

FIG. 8 is a side perspective view of the chair and the panel apparatus of FIG. 1.

FIG. 9 is the panel apparatus of FIG. 1 deployed on a front side of a chair seat back.

FIG. 10 is a side transparent view of an alternative embodiment user-changeable display panel apparatus of the invention.

FIG. 11 is a front view of a second embodiment panel apparatus of the invention deployed on a headboard.

FIG. 12 is a side view of the second embodiment panel apparatus and headboard of FIG. 11 together with a bed.

FIG. 13 a front view of a third embodiment panel apparatus of the invention deployed on a headboard.

FIG. 14 is a back view of a couch and a fourth embodiment user-changeable display panel apparatus of the invention.

### DETAILED DESCRIPTION

The following description is presented to enable any person skilled in the art to make and use the invention. For the purposes of explanation, specific nomenclature is set forth to provide a plural understanding of the present invention. While this invention is susceptible of embodiment in many different forms, this description describes and the drawings show specific embodiments of the invention with the understanding that the present disclosure is to be considered as an exemplification of the principles of the invention and is not intended to limit the invention to the specific embodiments illustrated.

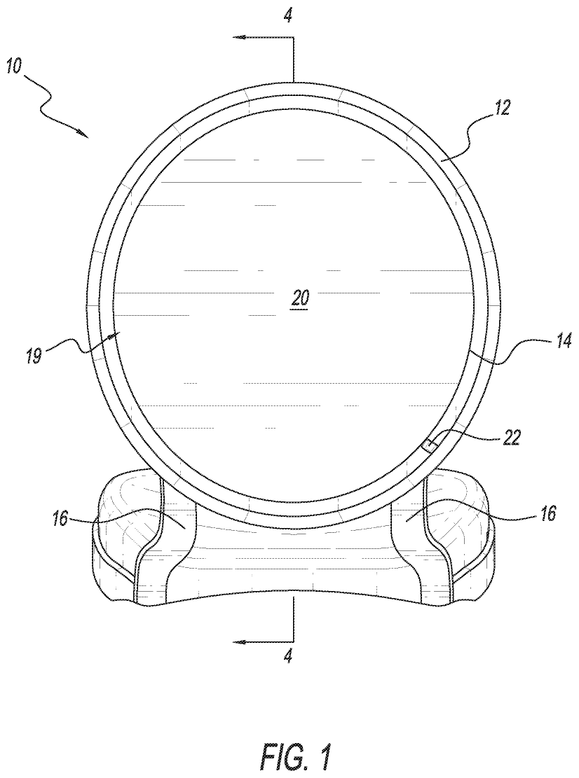

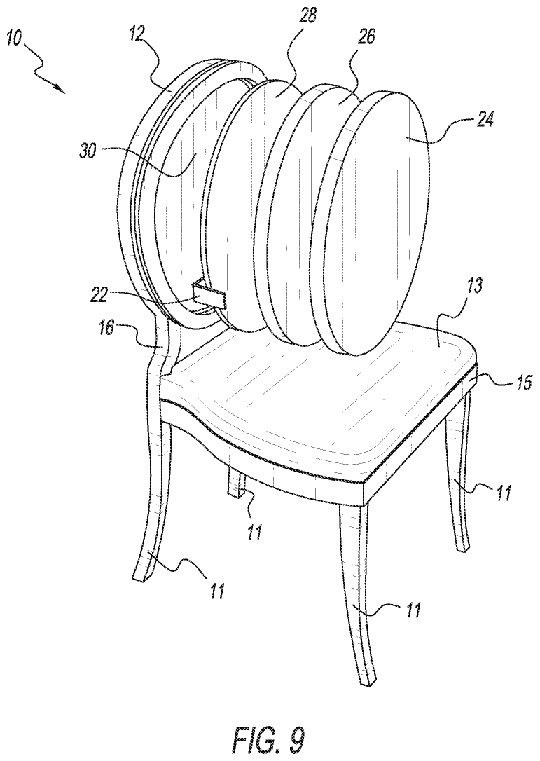

FIGS. 1 and 9 show a chair 10 comprising a user-changeable display panel apparatus 19. The panel apparatus 19 comprises a display panel 20 and a receiver panel 30.

In some embodiments, the display panel 20 comprises a cover 24 and an attachment element 28. The attachment element 28 is or comprises a magnet or magnetic sheet. In some embodiments, the magnetic sheet has a thickness of 1.5 millimeters. The cover comprises a display face 21. The cover may comprise one or more designs. In some embodiments, the cover 24 may comprise a fabric, textile, leather, and/or natural and/or synthetic materials, and such material may comprise one or more designs and/or structures. The cover may comprise embroidery or other features, structures, or elements that extend from a front surface of the cover. For example, the cover may comprise a flower element that extends from the front surface of the cover.

In some embodiments, the display panel 20 comprises a padding, cushion, or batting 26. The padding 26 is located between the display face 21 of the cover 24 and the attachment element 28. In some embodiments, the cover 24 comprises a perimeter edge cover portion 25 that extends over a perimeter edge 26a of the padding 26 and a perimeter edge 28a of the attachment element 28. In some embodiments, the perimeter edge cover portion 25 is unified and continuous with display face 21 of the cover 24.

In some embodiments, the cover 24 comprises a rear overlap portion 27, which overlaps an outer perimeter edge 28a of an attraction face 28c of the attachment element 28. The attraction face 28c is the magnetic side of the attachment element 28. In some embodiments, the rear overlap portion 27 is unified and continuous with the perimeter edge cover portion 25 and the portion of the cover 24 on the display side 21.

In some embodiments, the terminal end perimeter of the overlap portion 27 may comprise an elastic band 27a for holding the cover to the attachment element. The cover may also hold the padding to the attachment element via the elastic band. In some embodiments, the cover may be attached to the padding, such as by threads, an adhesive, and/or other suitable means, in addition or alternative to the use of an elastic band. And the padding 26 may be attached to the attachment element 28, such by threads, an adhesive, and/or other suitable means, in addition or alternative to the use of an elastic band.

In some embodiments, the attachment element 28 is coextensive or substantially coextensive, and therefore the same or substantially the same size, with the cover 24 and the face 21. The attachment element may also be coextensive with the padding 26. When the attachment element is coextensive or substantially coextensive with the cover, the attachment element imparts a secure fixation of the panel 20 to the receiver panel 30 throughout the entire face 21 of the cover. In some embodiments, the receiver panel 30 therefore is also at least as large as the attachment element so that the attachment element has something to join with throughout the extent of the attachment element. This can ensure a smooth and complete attachment and profile of the panel to the receiver panel 30 and the associated furniture. Therefore, in some embodiments, the receiver face 30a of the receiver panel 30 has an area that is the same, substantially the same, or greater than an area of the attraction face 28c of the attachment element 28.

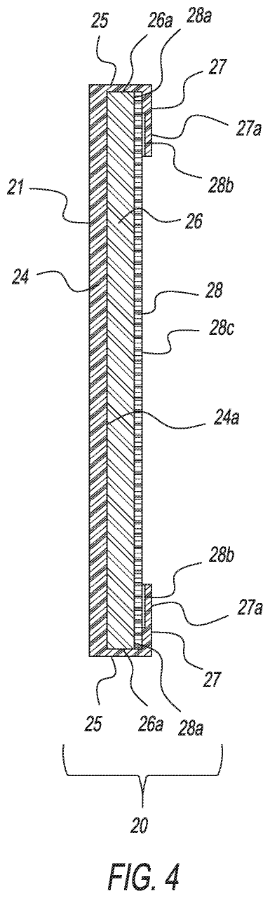

In some embodiments, the attachment element 28 is considered substantially coextensive with the cover 24 where the cover extends beyond the attachment element somewhat to surround the outer perimeter edges 26a and/or 28a of the padding 26 and or the attachment element 28 with the perimeter edge cover portion 25, such as shown in FIG. 4. The attachment element 28 occupies all of the area behind the face 21 of the cover except where the perimeter edge cover portion 25 extends around the outer perimeter edges 26a, 28a. Therefore, the attachment element is substantially co-extensive with the cover 24 and the face 21.

In some embodiments, the attachment element is located behind all of the face 21 of the cover 24, except the perimeter edge cover portion 25. In some embodiments, the attachment element comprises the same or substantially the same diameter as a diameter of the face 21 of the cover 24. In some embodiments, the attachment element 28 is oval shaped and comprises a major axis and a minor axis that is the same or substantially the same as the major axis and minor axis, respectively, of the face of the cover. In some embodiments, the attachment element 28 comprises a length and a width that is the same or substantially the same as the length and the width of the face 21 of the cover 24. In some embodiments, the attachment element comprises an attraction face 28c and the attraction face 28c comprises a surface area that is the same or substantially the same as the face 21 of the cover 24.

In some embodiments, the display panel 20 comprises a pull tab 22. The pull tab is fixed to the cover 24 and/or the padding 26 and/or the attachment element 28. The pull tab enables a user to grasp the tab and remove the display panel from its mount to the receiver panel 30, overcoming the magnetic attraction between the display panel and the receiver panel. The pull tab may be comprised of fabric or other materials that match or complement the appearance of the cover. In some embodiments, the pull tab may be translucent or transparent to reduce its visual prominence.

In some embodiments, the padding 26 comprises a thickness that is greater than, less than, or equal to the thickness of the attachment element 28.

In some applications, the chair comprises a frame 12. In some applications, the chair comprises a peripheral element, such as peripheral trim 14. The trim surrounds the central chair back area 29 wherein the display panel 20 is or is to be mounted. The central chair back area 29 comprises the receiver panel 30. In some embodiments, the receiving panel is a metal or a metal sheet. In some embodiments, the receiving panel is or comprises a ferromagnetic material. In some embodiments, the receiving panel is or comprises a flexible or bendable sheet. In some embodiments, the receiving panel has a thickness of about 0.5 millimeters. In some applications, the frame 12 can made of a variety of materials including but not limited to varieties of wood and metal. Further, the frame may be painted, stained, powder coated, or otherwise finished a desired one or more colors.

The receiver panel 30 can be mounted, including permanently mounted, to a support member 32, which is connected to the frame 12. In some embodiments and applications, the receiver panel 30 can replace support member 32 and act as a support member for the display panel 20. The receiver panel 30 can be mounted to and supported by the frame 12.

When the attachment element 28 is a magnet or magnetic sheet, the magnet joins the display panel to the receiver 30. In some embodiments, the attachment element 28 is at least as large as the receiver panel 30. When the attachment element 28 is substantially the same size as the cover 24, the attachment element 28 will draw the display panel into continuous contact with the receiver panel across the entire mating area between the attachment element and the receiver panel.

The use of a magnetic sheet, as the attachment element, covering the entire or substantially entirety of the back of the display panel, ensures a firm, smooth, and continuous affixation of the display panel to the chair back across the entire back surface area of the display panel. Further, this allows the display panel to be bendable and flexible to conform to the shape of the receiver panel. In some applications, the receiver panel comprises one or more curved contour(s) and the display panel adopts and conforms to the curved contour(s) when attached to the receiver panel. Therefore, in some embodiments, the display panel does not require a rigid frame or construction, reducing weight and expense, while comprising desirable contour confirming properties. In some applications, the receiver panel is flat or substantially flat and the display panel is or adopts the flat or substantially flat profile of the receiver panel.

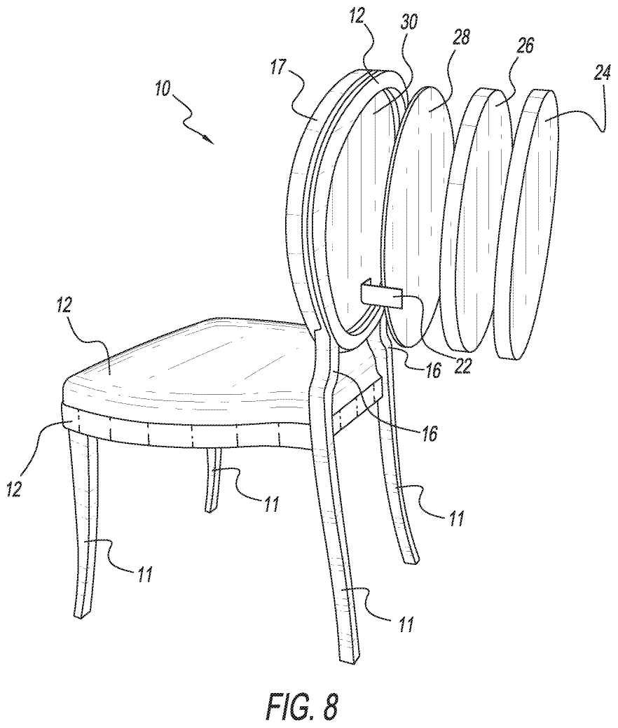

FIG. 8 shows more of the chair 10 from FIG. 1. In some embodiments, the chair comprises a plurality of legs 11 and a seat bottom 13 connected to a seat bottom frame 15. The seat bottom frame 15 may be integral with the frame or seat back frame 12 that holds the front seat back 17 and the panel apparatus 19, such as via seat back support arms 16.

FIG. 9 shows that the panel apparatus 19 can be provided or deployed on the front seat back, such at 17 of FIG. 8, which supports a user's back when seated.

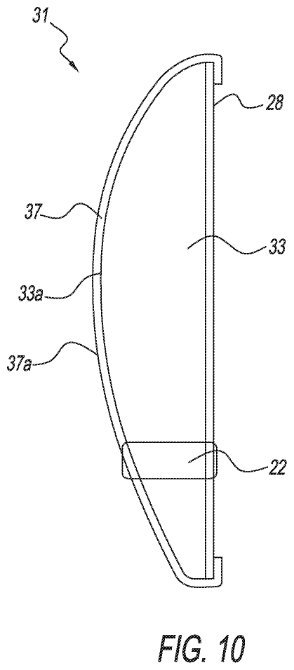

FIG. 10 shows an alternative embodiment display panel 31, which comprises the attachment element 28 of panel 20. The panel 31 also comprises a cover 37 and a padding, cushion, or batting 33. The cover 37 may be the same or similar to cover 24. The cover 37 may be sized differently than cover 24 to accommodate a different sized or shaped padding 33, as compared to padding 26. The padding 33 is shaped and/or sized differently than the padding 26. The padding 33 may have a curved or convex outer face 33a. The curved or convex outer face 33a imparts a curved or convex outer shape to the face 37a of the cover 37.

The panel 31 of FIG. 37 can be deployed on the back side of the chair as is shown with panel 20 in FIG. 1, or as a cushion on the seat bottom of a chair for a user to sit on, or on a front side of the seat back for supporting a user's back when seated. A receiver panel, such as the receiver panel 30, can be mounted or deployed under the seat of the chair, such as at 15 of FIG. 8, and or under the front side of the seat back, such as at 17 of FIG. 8, in order to enable the panel 31 to be removably installed in either or both of the seat bottom or seat back locations. Further, the panel 20 could also be used in either or both of the seat bottom or seat back locations.

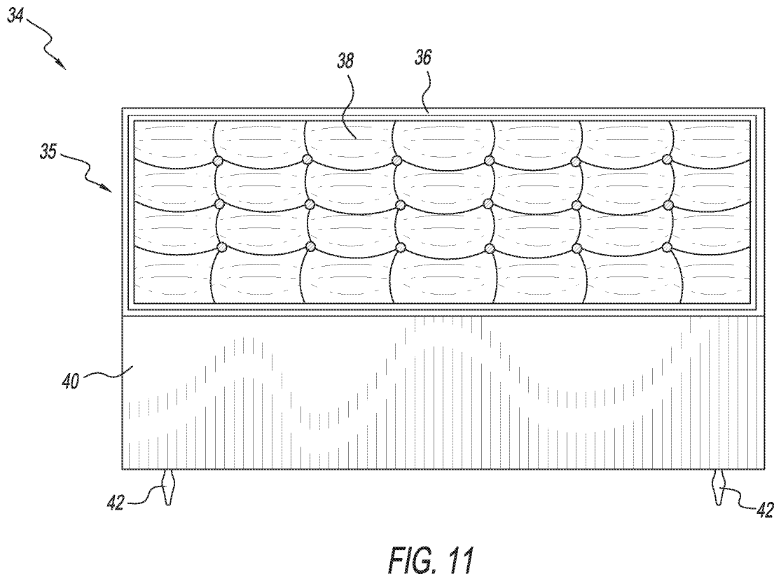

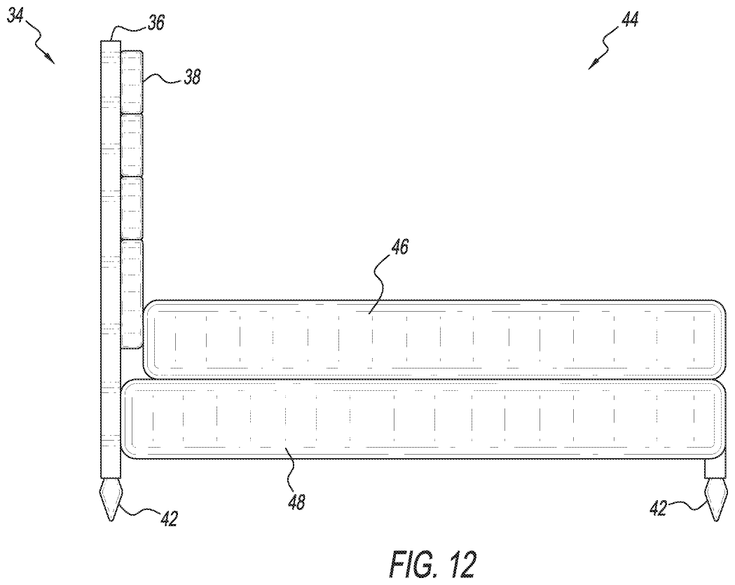

FIGS. 11 and 12 show a second embodiment user-changeable display panel apparatus 35. The apparatus 35 is the same as apparatus 19, except the shape and size of apparatus 35 is different from apparatus 19 and apparatus 35 is deployed on a headboard 34 instead of on a chair. The apparatus 35 comprises a display panel 38. The display panel 38 is the same as display panel 20, except the shape is rectangular and the size is larger than panel 20. Mounted to the headboard base 36, is a receiver panel (not shown). As was the case with apparatus 19, the receiver panel receives the attachment member (not shown) of apparatus 35 to releasably secure the display panel 38 to the headboard base 36. While the display panel 38 is shown with buttons and a tufted configuration, it will be appreciated that other surface designs for the display panel 38 could be provided, including ones that comprise a more flat or uniform surface or comprises grommets or any other designs. The base 36 may be an open lower area 40 below apparatus 35.

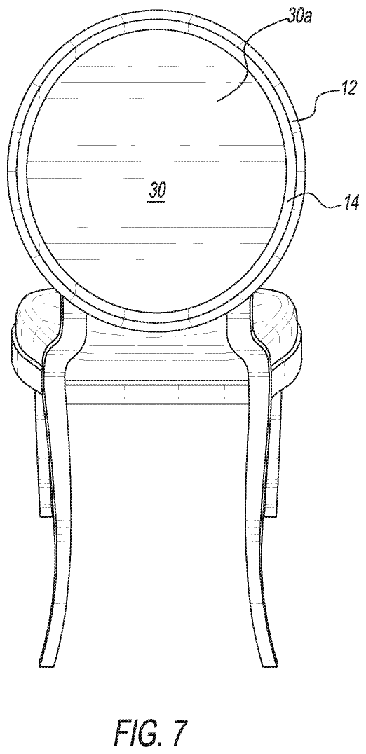

FIG. 12 shows a side view of the headboard 34 of FIG. 7 attached to a bed 44. The bed comprises a lower paneling and frame 48 and a mattress 46. The headboard and the bed are supported by legs 42. In some embodiments, the headboard does not have legs. In some applications, the headboard can be mounted to the wall. In some application, the headboard is separate from the bed. In some embodiments, one or more user-changeable display panel apparatus 35 is deployed, in addition or in the alternative, on the lower paneling 48 of the bed, where it is sized to fit the available or user preferred area of the lower paneling 48 or a portion or portions thereof.

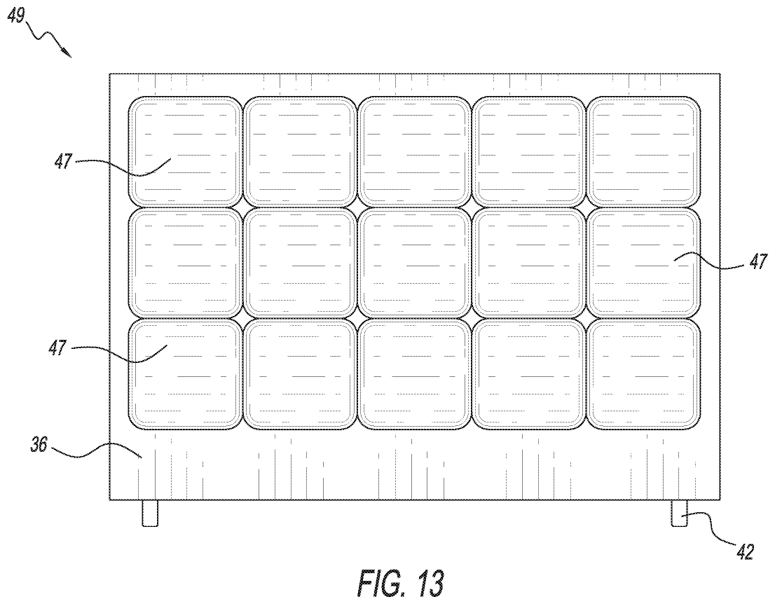

FIG. 13 shows a third embodiment user-changeable display panel apparatus 47 deployed in multiple on a headboard 49. In some embodiments, the apparatus 47 are arranged in rows and or columns, such as shown in FIG. 13. In some embodiments, the apparatus 47 are adjacent to each other and touching. The apparatus 47 is the same as apparatus 35, except the shape and size of apparatus 47 is different from apparatus 35, as shown in the figures. The display panels of the apparatus 35, 47 may be smaller, larger, longer, wider than as shown, with or without buttons, with grommets, with stitching, and may be rectangular, square, round, or other shapes.

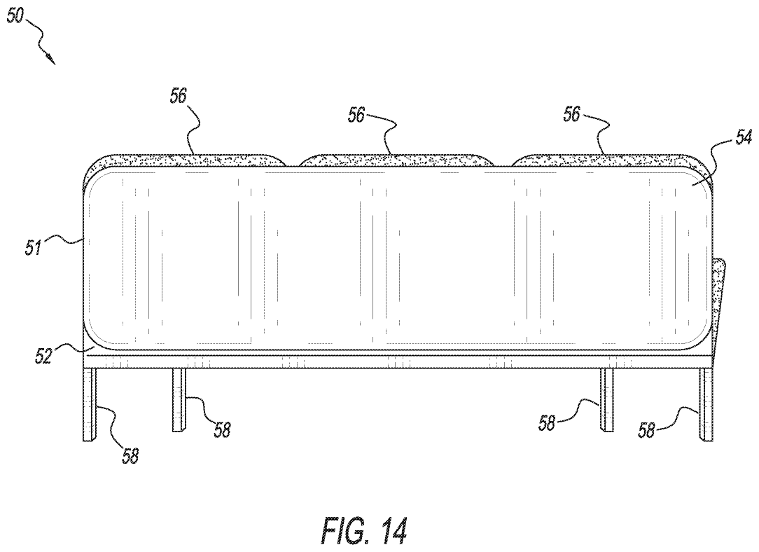

FIG. 14 shows a fourth embodiment user-changeable display panel apparatus 51. The apparatus 51 is the same as apparatus 19, except the shape and size of apparatus 51 is different from apparatus 19 and apparatus 51 is deployed on the back of a couch 50 instead of on a chair. The apparatus 51 comprises a display panel 54. The display panel 54 is the same as display panel 20, except the shape is rectangular and the size is larger than panel 20. Mounted to the couch back 52 is a receiver panel (not shown). As was the case with apparatus 19, the receiver panel receives the attachment member (not shown) of apparatus 51 to releasably secure the display panel 54 to the couch back 52. In some applications, the couch may comprise seat cushions 56 opposite the display panel 54. The couch may further comprise legs 58 for supporting it on the ground. The display panel 54 may be one piece, multiple panels, rectangular, square, round, or other shapes, and with or without buttons, grommets, and/or stitching.

To change the display panel of any of the display panel apparatus 19, 35, 47, 51 the user first removes the first display panel from a receiving panel of the furniture. This can be done by peeling the first display panel away from the receiving panel and overcoming the magnetic attraction of the first display panel to the receiving panel, the receiving panel comprising a ferromagnetic material. The user can begin this removal by grasping a tab, such as the tab 22, or otherwise grasping the edge of the first display panel with the user's hand.

After the first display panel is removed, the user can attach a second display panel. The user will attach the second display panel to the receiving panel by aligning the attachment element on a back of the second display panel with the receiving panel, or a portion thereof. Once there is alignment or partial alignment, the user will move the second display panel toward the receiving panel wherein the magnetic attraction of the attachment element to the ferromagnetic material of the receiving panel draws the second display panel to the receiving panel and supports the second display panel on the receiving panel. In some embodiment, the steps of aligning and moving occur at the same time. When the receiving panel is curved or contoured, the magnetic attraction of the attachment element to the ferromagnetic material causes the second display panel to confirm to the contour(s) of the receiving panel. Where the attachment element is substantially co-extensive with the cover and the ferromagnetic material of the receiving panel is at least co-extensive with the attachment element, then the magnetic attraction between the second display panel and the receiving panel secures the second display panel to the receiving panel throughout the extent of the second display panel.

The user-changeable display panel apparatus, including the receiving panel and the display panel can be sized, shaped, and/or contoured to match the desired furniture application or aesthetic. For example, user-changeable display panel apparatus, including the receiving panel and the display panel can have a perimeter that is circular, oval, curved, trapezoidal, square, rectangle, irregular or other shapes.

While the user-changeable display panel apparatus has been illustrated as a chair, headboard, and couch in the drawings, it can be deployed on other furniture. While the user-changeable display panel apparatus disclosed here are described as attached to furniture, it will be recognized that the furniture can be manufacture with the user-changeable display panel already installed on the furniture or the user-changeable display panel apparatus may be attached or retrofitted to existing furniture. Further, more than one user-changeable display panel apparatus can be used on a given piece of furniture.

From the foregoing, it will be observed that numerous variations and modifications may be affected without departing from the spirit and scope of the invention. It is to be understood that no limitation with respect to the specific apparatus illustrated herein is intended or should be inferred. For example, one or more component embodiments may be combined, modified, removed, or supplemented to form further embodiments within the scope of the invention. Further, steps could be added or removed from the processes described. Therefore, other embodiments and implementations are within the scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A furniture, comprising:
a frame;
a receiving panel comprising a ferromagnetic material supported by the frame; and,
a removable panel comprising a cover and a magnetic sheet, the magnetic sheet is opposite of the cover and configured to detachably connect to the receiving panel, the magnetic sheet is substantially coextensive with the cover.

13. The furniture of claim 12, wherein the furniture is a chair, which comprises:
a plurality of legs connected to the frame;
a seat bottom supported by the plurality of legs;
a seat back orientated transverse to the seat bottom and positioned adjacent to the seat bottom; and,
the seat back comprises the receiving panel.

14. The furniture of claim 12, wherein the furniture is a headboard, which comprises a front side and the front side comprises the receiving panel.

15. The furniture of claim 12 wherein the furniture is a couch, which comprises:
a plurality of legs connected to the frame;
a seat bottom supported by the plurality of legs;
a seat back orientated transverse to the seat bottom and positioned adjacent to the seat bottom; and
the seat back comprises the receiving panel.

16. The furniture of claim 13, wherein the frame supports the seat back, the frame comprising a perimeter frame, a back side of the seat back comprising the perimeter frame, the perimeter frame surrounds the receiving panel and defines a space for the receiving panel.

17. The furniture of claim 12, wherein the display panel comprises a pull tab extending from a perimeter of the display panel.

18. The furniture of claim 12, wherein the display panel comprises a padding material between the cover and the magnetic sheet.

19. The furniture of claim 12, wherein the cover comprises a convex curved face.

20. A method of changing upholstery of furniture, comprising the steps of:
removing a first display panel from a receiving panel of the furniture by peeling the first display panel away from the receiving panel and overcoming the magnetic attraction of the first display panel to the receiving panel, the receiving panel comprising a ferromagnetic material; and,
attaching a second display panel to the receiving panel, by aligning a magnetic sheet on a back of the second display panel with the receiving panel, wherein a cover of the second display panel is opposite the magnetic sheet, and moving the second display panel toward the receiving panel wherein the magnetic attraction of the magnetic sheet to the ferromagnetic material of the receiving panel draws the second display panel to the receiving panel, wherein the magnetic sheet is substantially co-extensive with the cover, the ferromagnetic material is at least co-extensive with the magnetic sheet so that the magnetic attraction between the second display panel and the receiving panel secures the second display panel to the receiving panel throughout the extent of the second display panel.

21. The furniture of claim 12, wherein the cover comprises an upholstery.

22. The furniture of claim 12, wherein the cover comprises a fabric and the fabric is joined to the magnetic sheet.

23. The furniture of claim 12, wherein the cover defines a semi-enclosed space, a back side of the cover is in communication with the semi-enclosed space, the magnetic sheet covers the back side of the cover.

24. The furniture of claim 12, wherein the magnetic sheet comprises a rear surface area that is substantially the same as a surface area of a display face of the cover.

25. The furniture of claim 12, wherein the magnetic sheet comprises a sheet diameter and a display face of the cover comprises a display diameter, the sheet diameter is substantially equal to the display diameter.

26. The furniture of claim 12, wherein a surface area of the receiving panel is substantially equal to a surface area of a display face and a surface area of the magnetic sheet.

27. The furniture of claim 12, wherein the display panel is flexible, the receiving panel comprises a curved profile, and the display panel conforms to the curved profile of the display panel when connected to the receiving panel.

28. The furniture of claim 12, comprising an upholstery supported by the frame.

29. The furniture of claim 16, wherein,
the cover is joined to the magnetic sheet;
the display panel comprises a padding material between the cover and the magnetic sheet; and,
wherein the magnetic sheet comprises a rear surface area that is substantially the same as a surface area of a display face of the cover.

30. The furniture of claim 29, wherein:
the cover defines a semi-enclosed space, a back side of the cover is in communication with the semi-enclosed space, the magnetic sheet covers the back side of the cover to enclose the semi-enclosed space, the padding material is within the semi-enclosed space.

31. A chair, comprising:
a frame;
a receiving panel comprising a ferromagnetic material supported by the frame; and,
a removable panel comprising a cover and a magnetic sheet, the magnetic sheet is opposite of the cover and configured to detachably connect to the receiving panel, the magnetic sheet is substantially coextensive with the cover;
at least four legs connected to the frame;
a seat bottom supported by the frame;
a seat back supported by the frame and orientated transverse to the seat bottom and positioned adjacent to the seat bottom; and
a back side of the seat back comprises the receiving panel.
